(19) United States
(12) Patent Application Publication
(10) Pub. No.: US 2023/0328003 A1
(43) Pub. Date: Oct. 12, 2023

(54) MANAGING MULTIPLE SELLERS OF RECORD FOR CLOUD SERVICES USING A SINGLE CLOUD MANAGEMENT SERVICE

(71) Applicant: VMware, Inc., Palo Alto, CA (US)

(72) Inventors: Rahul Agarwal, Sunnyvale, CA (US); Rockne J. Egnatios, Sammamish, WA (US); Jahnavi Mukesh Patel, Sunnyvale, CA (US); Alex Rankov, Medford, OR (US); Sunil Kumar, San Jose, CA (US); Narayan Bharadwaj, Palo Alto, CA (US); Srinivasan Seetharaman, San Jose, CA (US); Suresh Babu Bashyam, Palo Alto, CA (US); Oren Daniel Root, Palo Alto, CA (US); Vijayakumar Kothandaraman, San Jose, CA (US)

(21) Appl. No.: 17/717,279

(22) Filed: Apr. 11, 2022

(51) Int. Cl. H04L 47/762; H04L 47/78; H04L 47/80; H04L 47/783; H04L 47/70

(52) U.S. Cl. CPC H04L 47/762; H04L 47/781; H04L 47/803; H04L 47/787; H04L 47/822

(57) ABSTRACT

Described herein are systems, methods, and software to manage multiple sellers of record in a cloud computing environment. In one example, a cloud management service can monitor resource usage in association one or more cloud service providers for each seller of record of a plurality of sellers of record for a customer organization. The cloud management service can further identify interface requirements for reporting the usage information to each of the sellers of record and can communicate the corresponding usage information to each of the sellers of record.

### TECHNICAL BACKGROUND

Cloud service providers are important entities to a variety of different customers, wherein the customers may use the cloud service providers to provide Software-Defined Data Centers (SDDCs), networking services and subscriptions, workloads, or other services. Each cloud service provider may provide physical computing resources, including host computers, networking devices, and the like to support the services selected by the customers. The cloud service providers may operate in different geographic regions, provide different pricing and deployment options, provide different hardware solutions, or provide some other difference in service.

In some implementations, a customer may desire to deploy services across multiple cloud service providers. However, managing the services across the different cloud service providers can be difficult, cumbersome, and expensive. Additionally, migration of services can be difficult or impossible as a central management organization or service is unavailable to initiate the migration of the services from one cloud service provider to another or manage the billing requirements associated each seller of record for the various services. Further, current cloud service providers or sellers of record for the cloud service providers may incentivize customers through volume discounts or long-term commitments, creating a barrier for the customer to switch between cloud service providers.

### SUMMARY

The technology described herein provides centralized management for a customer organization to select desired sellers of record for services across cloud service providers. In one implementation, a method includes monitoring resource usage in association with one or more cloud service providers for each seller of record of a plurality of sellers of record for a customer organization. The method further provides, for each seller of record of the plurality of sellers of record, identifying interface requirements associated with reporting the resource usage for the seller of record and communicating the resource usage for the seller of record to a computing device associated with the seller of record in accordance with the interface requirements.

### BRIEF DESCRIPTION OF THE DRAWINGS

FIG. 1 illustrates a computing environment to manage sellers of record from a single cloud management service according to an implementation.

FIG. 2 illustrates an operation of a cloud management service according to an implementation.

FIG. 3 illustrates a timing diagram of initiating services in association with a new seller of record according to an implementation.

FIG. 4 illustrates a timing diagram of migrating services from a first seller of record to a second seller of record according to an implementation.

FIG. 5 illustrates a computing system to manage sellers of record for a customer organization in a cloud environment according to an implementation.

### DETAILED DESCRIPTION

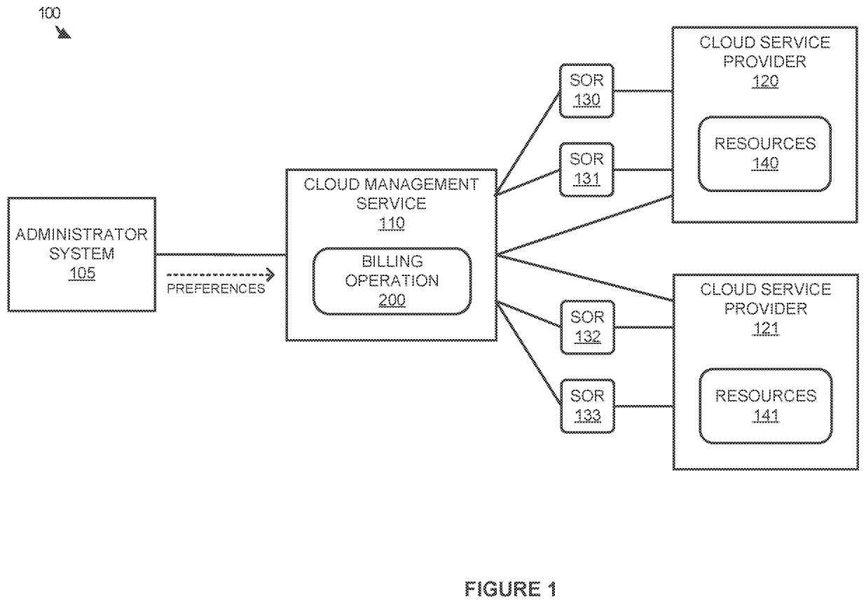

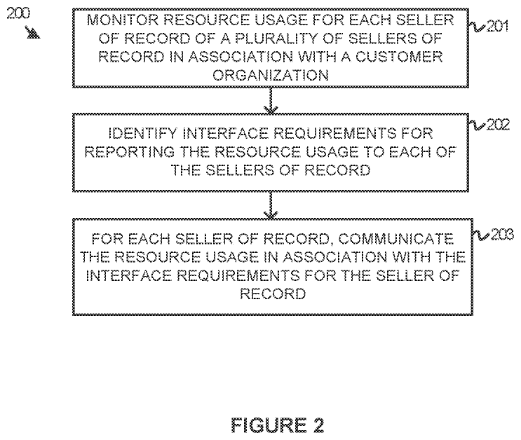

FIG. 1 illustrates a computing environment 100 to manage sellers of record from a single cloud management service according to an implementation. Computing environment 100 includes administrator system 105, cloud management service 110, sellers of record (SOR) 130-133, and cloud service providers 120-121. Cloud service providers 120-121 further include resources 140-141, wherein resources 140-141 may comprise physical host computers, routers, switches, or some other physical resource to support numerous services including Software-Defined Data Centers (SDDCs), applications, including firewalls and other security operations, workloads, or some other service. Cloud management service 110 provides operation 200 that is further described below with respect to FIG. 2. Although demonstrated with two cloud service providers in the example of computing environment 100, any number of cloud service providers can be supported using cloud management service 110. Further, while demonstrated with two sellers of record in association with each cloud service provider, any number of sellers of record can sell the resources associated with a cloud service provider. The sellers of record may comprise the cloud service provider itself, a distributer, or some other seller of record with an agreement to sell resources of the cloud service provider. Moreover, while the sellers of record are each demonstrated in association with a single cloud service provider, the sellers of record may sell services across multiple cloud service providers. Examples of cloud service providers may include Amazon Web Service™, Microsoft Azure™, Google™, or some other cloud service company.

In computing environment 100, administrator system 105 is representative of a customer organization (e.g., company, division of company, or some other entity) that can deploy services across multiple cloud service providers 120-121. The services may comprise SDDCs, applications, such as database applications, workloads, security services, or some other service. The services can be deployed across one or more host computers at each cloud service provider of cloud service providers 120-121. The services can be deployed as virtual machines, containers, or some other virtualized endpoint. The services may further include services to provide networking, firewalls, or some other service.

To initiate the services in cloud service providers 120-121, cloud management service 110 may act as an intermediary that indicates options associated with available sellers of record for the cloud service providers. The options may indicate services supported by each of the sellers of record, advertised costs associated with each of the sellers of record, or some other information for selecting a seller of record. A seller of record may have its own payment types, payment terms, subscriptions, regions of availability, product or service catalogue, billing engine, service level agreements and terms of service, or some other requirement for selling services to the customer organization. Once option information is provided to administrator system 105, the user may select a seller of record. The seller of record can be contacted directly through cloud management service 110 or can contact the seller of record via email, phone, website associated with the seller of record, or some other mechanism. The administrator may then select one or more services, resource requirements for the one or more services (processing resources, memory resources, storage resources, and the like), billing or subscription terms for the one or more services, or some other agreement for deploying the one or more services in a cloud service provider associated with the seller of record.

As an example, a user at administrator system 105, which may comprise a desktop computer, laptop computer, tablet, or some other end user device may request to deploy a SDDC from seller of record 130. Seller of record 130 may be a distributor associated with cloud service provider 120, a reseller associated with cloud service provider 120, or may comprise a branch of cloud service provider 120 itself. In response to the request, the user may communicate with seller of record 130 to negotiate the terms associated with deploying the SDDC. The seller of record may comprise one or more computing devices, including servers, routers, or some other computing device. The terms may establish the costs associated with the SDDC, a quality of service (e.g., resources available) for the SDDC, a term length, or some other agreement. Once the terms are established, seller of record 130 can indicate the selection of the SDDC service to cloud management service 110, permitting cloud management service 110 to initiate the deployment of any required resources in cloud service provider 120, and the user to manage the deployment of the SDDC via cloud management service 110.

After deploying the SDDC, cloud management service 110 may monitor usage information associated with the SDDC. The usage information may be supplied or retrieved at least partially from an agent for resources 140, wherein the usage information can comprise processing resource usage, memory resource usage, network interface usage, a quantity of virtual endpoints used, service identifiers associated with the service types deployed, or some other usage information. The usage can be provided periodically, during network downtimes, or at some other interval. In some examples, the usage information is fetched from the cloud service provider at frequent intervals. The usage information can be stored in a data store for cloud management service 110, wherein the usage in the store can be segregated for different sellers of record associated with the customer organization. The agent can be a representative of cloud management service 110, wherein cloud management service 110 can deploy products in the cloud service provider. Cloud management service 110 may provide hypervisor software and/or hardware at the cloud service providers, software defined networking services, or some other service supported using hardware resources operated by the cloud service providers. The cloud service providers may support all the appliances and services associated with cloud management service 110 or may support a subset of the appliances and services.

In some implementations, the resource usage may correspond to one or more service identifiers for services deployed by a customer organization. Rather than monitoring the physical resources at the cloud service provider, cloud management service 110 may monitor whether a service associated with a fixed cost is deployed. For example, a firewall service deployed in cloud service provider 120 by seller of record 130 may be billed at a flat rate. Thus, the resource usage may indicate that the service is active for the customer organization, limiting the requirement for resource monitoring at the cloud service provider. In some examples, the types of resources monitored for each service are specified by the seller of record. In other examples, at least a portion of the types or resources monitored for the services are provided by cloud management service 110, wherein each seller of record can use the same resource usage information to support billing the organization.

As the resource usage is monitored by cloud management service 110, cloud management service 110 may distribute usage information to the corresponding sellers of record. For example, the customer organization associated with administrator system 105 may use seller of record 130 to provide a first service at cloud service provider 120 and seller of record 132 to provide a second service at cloud service provider 121. Accordingly, the usage information associated with the first service (physical resource usage, service identifier, active status, and the like) can be provided to seller of record 130, while the usage information associated with the second service can be provided to seller of record 132. In distributing the usage information to the sellers of record, cloud management service 110 may identify and use interface requirements associated with each of the sellers of record. The interface requirements may include application programming interface (API) requirements, customer identifier information, usage information (i.e., physical resource usage, service identifiers for services deployed, etc.), or some other information.

Although demonstrated in the example of computing environment 100 using a single customer organization, cloud management service 110 may support multiple customer organizations. Each customer organization may deploy different services to different cloud service providers using one or more sellers of record. Cloud management service 110 may facilitate the deployment and migration of services, the usage information associated with each of the customer organizations and sellers of record, and the communication of the usage information to each of the sellers of record.

Further, while demonstrated in the example of computing environment 100 using a single seller of record between cloud management service 110 and cloud service providers 120-121, any number of tiers of resellers, distributors, and the like may exist between cloud management service 110 and cloud service provider 120. For example, although not illustrated, another seller of record may exist between seller of record 132 and cloud service provider 121. When the resource usage is measured in association cloud service provider 121, the resource usage is supplied to seller of record 132. Seller of record 132 can then be responsible for providing any billing information to the intermediary seller of record between cloud service provider 121 and seller of record 132.

FIG. 2 illustrates an operation 200 of a cloud management service according to an implementation. The steps of operation 200 are referenced parenthetically in the paragraphs that follow with reference to systems and elements of computing environment 100 of FIG. 1.

Operation 200 includes monitoring (201) resource usage in association with one or more cloud service providers for each seller of record of a plurality of sellers of record for a customer organization. As described previously, an organization may desire to implement services in one or more cloud service providers using multiple sellers of record. For example, cloud service provider 120 may be used to support a SDDC for a customer represented by administrator system 105, while cloud service provider 121 may provide support for one or more database workloads. In some implementations, cloud management service 110 provides options to a user at administrator system 105 that permits the user to select a seller of record or multiple sellers of record to provide desired services. When a seller of record is selected, the user may communicate with the seller of record to establish terms associated with deploying one or more services from the seller of record. Once established, cloud management service 110 receives a notification from the seller of record, permitting the desired one or more services to deployed. The services can be deployed automatically by cloud management service 110 or by request of the user associated with customer organization.

Once the services are deployed for the customer organization, cloud management service 110 monitors the resource usage for each of the sellers of record associated with the customer organization. For example, the customer organization may deploy a first service at cloud service provider 120 using seller of record 130 and deploy a second service at cloud service provider 121 using seller of record 131.

In some implementations, the usage information may be provided by one or more agents at the cloud service providers that act on behalf of cloud management service 110 to provide information about the resource usage in each of the cloud service providers. In some examples, the agents may execute on the same hardware as the deployed services. In some examples, at least a portion of the usage information can be maintained and monitored locally by cloud management service 110, wherein the usage information can include identifiers for services active in each cloud service provider, number of virtualized endpoints deployed, types of virtual networking appliances deployed, and the like. In one example, cloud management service 110 may identify that a service is active in a cloud service provider and maintain the active status as the requisite resource usage. Advantageously, the active status can be used by sellers of record that use a flat fee in billing for the service.

In addition to monitoring information about the resource usage, operation 200 further identifies (202) interface requirements associated with reporting the resource usage to each of the sellers of record associated with the customer organization. In some implementations, each of the sellers of record maintain different billing systems that use different information and formatting. Each of the sellers of record may use different payment types, terms, pricing structure, or some other information. For example, a first seller or record can bill at a first rate in association with processing resources, while a second seller of record can bill at a second rate in association with processing resources. The interface requirements identified by cloud management service 110 may comprise at lease API information associated with how to report usage information in a manner recognized by the corresponding seller of record. For example, seller of record 130 may correspond to a first set of APIs, while seller of record 131 corresponds to a second set of APIs. The interface requirements may further include the types of usage information that are required to support the billing and sale of the services, formatting information for the usage information, customer identifier information associated with the customer organization, or some other interface requirements. For example, the interface requirements for a first seller of record may require an indication of whether a service is active, while the interface requirements for a second seller of record may require physical resource usage information derived from the agents in the cloud service provider environment. In some implementations, the seller of record indicates at least a portion of the interface requirements to cloud management service. In some implementations, cloud management service 110 maintains at least a portion of the interface requirements, wherein the requirements may include usage information required in association with different services, API information, or some other interface requirement.

After the interface requirements are identified, operation 200, for each seller of record, communicates (203) the resource usage for the seller of record to a computing device or devices in accordance with the interface requirements. The usage information may be communicated periodically, based on usage satisfying one or more criteria, based on requirements for the cloud service provider, or at some other interval. In some implementations, the usage information is communicated to the seller of record in accordance with the API information associated with the seller of record. The usage information communicated to a seller of record may be specific to the seller of record (e.g., information required for billing from the seller of record), may be in a specific format for the seller of record, and may be communicated using a unique customer identifier for the customer organization. In some examples, the types of usage information monitored for a seller of record may be determined based on the one or more services sold (or subscriptions purchased) via the seller of record. This can permit the monitored resource usage for a first service to include first information, while the monitored resource usage for a second service can include second information. Once the resource usage is received by an individual seller of record for the customer organization, the seller of record may generate one or more bills that can be communicated directly to the customer organization.

In at least one example, the resource usage associated with the services can be stored in a first format by cloud management service 110. The usage can then be converted into a format associated with each individual seller of record based on the interface requirements associated with the seller of record. The interface requirements may be provided by each seller of record, may be defined by an administrator at cloud management service 110, or may be defined by some other mechanism. In some examples, the formats may change as a function of time, wherein the changes to the format associated with each seller of record may occur based on a change in services provided, a change in subscription or sales structure, or some other event.

In some implementations, cloud management service 110 provides feedback to administrator system 105 that can indicate the resource usage associated with each of the sellers of record or cloud service providers, status information associated with the services in the one or more cloud service providers, pricing information or advertisements, or some other information. For example, after deploying services in cloud service providers 120-121, cloud management service 110 receives resource usage information in association with the services. Cloud management service then provides, as a visual summary, the resource usage information for the sellers of record responsible for the services and can provide additional information for the user. The additional information can include the available resources based on the plan or subscription selected from the seller of record, any promotional information associated with each of the sellers of record, or some other information.

In some examples, cloud management service 110 may determine suggested sellers of record for an organization. The suggested sellers of record may be determined based on the advertised costs associated with each of the sellers of record, the types of services or hardware available via the sellers of record, or some other factor. Cloud management service 110 may further consider the types of services required by the customer, the current resource usage of the customer organization across one or more cloud service providers, or some other use case information associated with the customer organization. For example, the customer organization associated with administrator system 105 may initially deploy one or more services using seller of record 130 and cloud service provider 120. Cloud management service 110 may monitor the resource usage for the customer in cloud service provider 120 and may further identify advertised costs from the available sellers of record, the services or hardware associated with the available sellers of record, or some other factor. From the monitored information, cloud management service 110 may provide a list of one or more available sellers of record, wherein the list may be used as a suggestion for the user. For example, to generate a list, cloud management service 110 can score the sellers of record based on any number of the aforementioned factors and prioritize or select a subset of the sellers of record for the list provided to the user. The list may further highlight or otherwise indicate costs associated with the sellers of record, hardware, services, or cloud service providers available from the sellers of record, or some other information associated with the sellers of record.

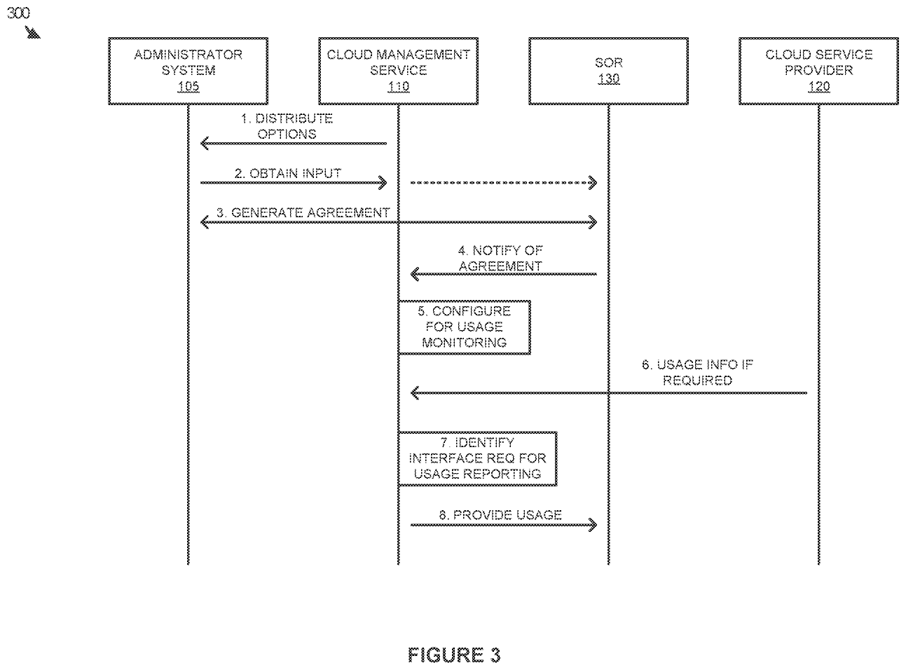

FIG. 3 illustrates a timing diagram 300 of initiating services in association with a new seller of record according to an implementation. Timing diagram 300 includes administrator system 105, cloud management service 110, seller of record 130, and cloud service provider 120 from FIG. 1.

In timing diagram 300, cloud management service 110 may distribute options to administrator system 105 at step 1. The options may include information about multiple sellers of record, including advertised costs, regions of availability, subscription plans, available services, and cloud service providers from each seller of record, or some other information in association with the sellers of record. After providing the options, a user at administrator system 105 may provide input that selects a seller of record 130 at step 2. In some implementations, in response to a selection, cloud management service 110 can facilitate the connection with the selected seller of record. In other examples, cloud management service 110 forwards the request to web portal, email, or some other service associated with the seller of record. In some examples, although not illustrated in timing diagram 300, the user of administrator system 105 may contact seller of record 130 directly without the use of cloud management service 110.

After selecting seller of record 130, the user of administrator system 105 may generate an agreement for deploying one or more services in cloud service provider 120 at step 3. The agreement may include service identifiers for the one or more services, subscription cost, length, quality of service requirements, or some other information deploying the one or more services in cloud service provider 120. Once the agreement is generated, cloud management service 110 receives a notification of the agreement at step 4, wherein the notification may indicate the one or more services available for the customer organization, the cloud service provider for deploying the one or more services, quality of service information for the one or more services, or some other information. In response to receiving the notification, cloud management service 110 may automatically initiate the one or more services or may receive user input from the customer organization for deploying the one or more services (e.g., selecting virtual machines to be deployed in a SDDC), and may initiate the one or more services in cloud service provider 120. In some examples, cloud management service 110 may provide software, including hypervisor software, virtual networking appliances, and the like that can be employed on multiple cloud service providers.

In addition to managing the deployment of the one or more services, cloud management service 110 can be configured to monitor resource usage associated with the one or more services at step 5. Monitoring resource usage may include determining when a service is active, determining physical computing resources used in association with the one or more services, or can comprise some other monitoring tool. Accordingly, an agent at cloud service provider 120 may communicate at step 6 any usage information if required in association with the one or more services deployed at cloud service provider 120. In some examples, the resource usage information monitored may be dependent on the type of service deployed. For example, a first service may include resource usage information that indicates whether the first service is deployed, while a second service may include resource usage information that monitors the number of virtual machines deployed and physical processing resources used by the second service.

As the resource usage is monitored, cloud management service 110 identifies interface requirements for reporting the usage to seller of record 130 at step 7. The interface requirements can include API requirements, types of usage information, formatting requirements, or some other interface requirement. Once identified, cloud management service 110 provides the resource usage to seller of record 130 at step 8. The resource usage can be reported periodically, when the resource usage satisfies criteria (e.g., a service is deployed by customer organization), or at some other interval. The resource usage can be communicated to one or more computing devices, such as server computers, that represent the seller of record, or a billing department associated with the seller of record. Once the resource usage is received by an individual seller of record for the customer organization, the seller of record may generate one or more bills that can be communicated directly to the customer organization

Although demonstrated using a selection of a single seller of record, a customer organization may employ multiple sellers of record to deploy the required environment. Multiple sellers of record may facilitate better pricing for different services, may provide different services, may provide different geographic region support, or may facilitate some other deployment advantage. Accordingly, the customer organization associated with administrator system 105 may deploy a first service using seller of record 130 in cloud service provider 120 and may deploy a second service using a second seller of record that can be associated with the same cloud service provider or a different cloud service provider.

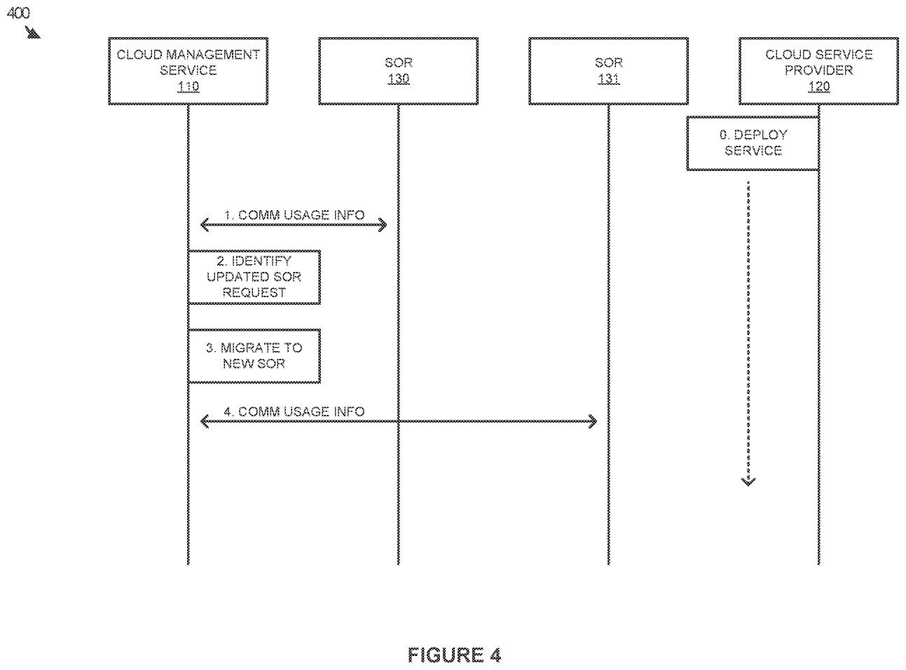

FIG. 4 illustrates a timing diagram 400 of migrating services from a first seller of record to a second seller of record according to an implementation. Timing diagram 400 includes cloud management service 110, sellers of record 130-131, and cloud service provider 120 from FIG. 1.

In timing diagram 400, cloud service provider 120 deploys, at step 0, a service for a customer organization, wherein the service may comprise a SDDC, firewall, data processing workload, or some other service. In deploying the service, the customer organization may use a first seller of record 130, wherein the first seller of record may include a first pricing structure, a first subscription term, a first service level agreement, or some other agreement with the customer organization. Cloud management service 110 communicates resource usage information to seller of record 130 at step 1, wherein the usage information can be obtained from cloud service provider 120 or can be maintained at least partially at cloud management service 110. The resource usage may include an indication that a service is deployed, the physical resources used by the service, or some other resource usage information. The resource usage can be communicated periodically, after a request from seller of record 130, or at some other interval.

As cloud management service 110 maintains and communicates resource usage to seller of record 130, cloud management service 110 identifies a request to update the seller of record for the service to seller of record 131. In some implementations, seller of record 131 can provide the notification to cloud management service 110. The notification can be communicated following an agreement between the customer organization and the seller of record. The notification may include resource usage requirements or other interface requirements for communicating the usage information to the new seller of record. After receiving the notification, cloud management 110 initiates a migration to the new seller of record 110 at step 3. This may include updating the monitoring of the usage information such that the resource usage of the service is associated with seller of record 131 in place of seller of record 130. The migration may include updating the types of usage monitored for the service, API requirements for the new seller of record, formatting for the resource usage, or some other update. After migrating to seller of record 131, cloud management service 110 communicates usage information to seller of record 131 in place of seller of record 130 at step 4.

Although demonstrated in FIG. 4 as maintaining the same cloud service provider and migrating to a new seller of record, cloud management service 110 may also facilitate the migration to different cloud service providers. As an example, when the customer organization creates a new contract with seller of record 131, the new seller of record can be associated with a different cloud service provider or sell the services of another cloud service provider. In response to the notification from seller of record 131 and in some examples a confirmation from a user associated with the seller of record, cloud management service 110 may initiate the migration of the service from cloud service provider 120 to a second cloud service provider. Each of the cloud service providers may support the same appliances and services from cloud management service 110 or may support a subset of the services and appliances. The seller of record may indicate the available services at an associated cloud service provider. The migration may include migrating virtual machines, containers, or other appliances, providing configuration parameters, such as IP addressing information, firewall configurations, and the like, or some other migration between cloud service providers.

Although demonstrated in the examples of FIGS. 1-4, using a single customer organization and administrator system 105, cloud management service 110 may manage the orchestration of services for multiple organizations. In some implementations, the cloud management service 110 may maintain separate customer identifiers for each of the customer organizations, different usage information associated with the different customer organizations, and can distribute the usage information as required to the different sellers of record. Accordingly, the different customer organizations may each deploy services using sellers of record with different pricing, service levels, or some other configuration difference. Further, each of the customer organizations may add sellers of record, change to different sellers, or remove sellers of record using a centralized cloud management service 110.

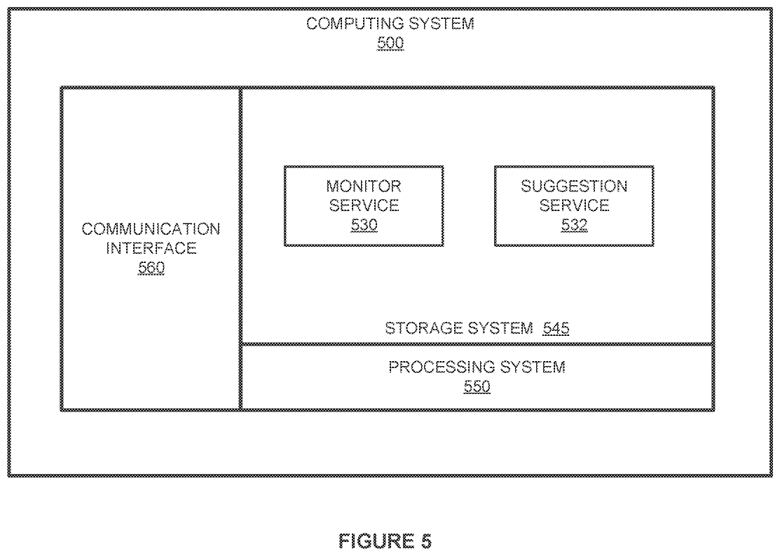

FIG. 5 illustrates a computing system 500 to manage sellers of record for a customer organization in a cloud environment according to an implementation. Computing system 500 is representative of any computing system or systems with which the various operational architectures, processes, scenarios, and sequences disclosed herein for a cloud management system can be implemented. Computing system 500 is an example of cloud management system 110 of FIG. 1, although other examples may exist. Computing system 500 includes storage system 545, processing system 550, and communication interface 560. Processing system 550 is operatively linked to communication interface 560 and storage system 545. Communication interface 560 may be communicatively linked to storage system 545 in some implementations. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format—including combinations thereof. Communication interface 560 may be configured to communicate with computers associated with one or more cloud service providers. The cloud service providers may include hosts, networking devices, such as routers and switches, user computing systems, billing computers, or some other computing system.

Processing system 550 comprises microprocessor and other circuitry that retrieves and executes operating software from storage system 545. Storage system 545 may include volatile and nonvolatile, removable, and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises monitor service 530 and suggestion service 532. The operating software on storage system 545 may further include an operating system, utilities, drivers, network interfaces, applications, or some other type of software. When read and executed by processing system 550 the operating software on storage system 545 directs computing system 500 to operate as described herein. In at least one example, the operating software can provide at least operation 200 described above in FIG. 2.

In at least one implementation, monitor service 530 directs processing system 550 to monitor resource usage in association with one or more cloud service providers for each seller of record of a plurality of sellers of record for a customer organization. The resource usage may be received, at least in part, from agents in the one or more cloud service providers, but may also include information maintained locally at computing system 500. The local information can include the number of deployments of a service, whether a service is active, or some other resource usage. Monitor service 530 further directs processing system 550 to, for each seller of record associated with the customer organization, identify interface requirements associated with reporting the resource usage for the seller of record and communicate the resource usage for the seller of record to at least one computing device associated with the seller of record in accordance with the interface requirements. The interface requirements may comprise API requirements, types of resource usage information required, formatting requirements, or some other requirement.

In addition to monitoring and communicating resource usage to different sellers of record, suggestion service 532 can direct processing system 550 to provide a list of one or more available sellers of record available for selection by the customer organization to provide the required services. The list may provide information about each of the sellers, such as regions available for each of the sellers, advertised costs associated with each of the sellers, services or applications supported by each of the sellers, hardware available from each of the sellers (or associated cloud service providers), or some other information associated with the available sellers of record. From the list, a user may select one or more sellers of record and deploy services based on agreements with each of the sellers of record. In some implementations, when a seller of record is selected, the user is connected to a sales system associated with the seller of record that can negotiate the terms of the subscription, resource requirements, and the like. Once negotiated and computing system 500 is notified of the agreement, the services can be deployed and configured. The configuration may include deploying virtualized endpoints, configuring one or more agents to report the resource usage information, configuring one or more virtual networks, or providing some other configuration information in association with the desired services.

In some examples, suggestion service 532 directs processing system 550 to generate a list of one or more suggested sellers of record for a customer organization. The list of one or more sellers of record can be selected from a set of seller or record based on a variety of factors. The factors may include the advertised costs associated with the sellers of record, the locations or geographic regions supported by sellers of record or the associated cloud service providers, services or applications supported by the cloud service provider(s) for the sellers of record, previous seller of record selections by the current organization or other organizations, or some other information about the sellers of record and associated cloud service providers. The factors may further include usage information in association with the current service deployment for a customer organization. For example, a first deployment of services may use two different sellers of record and suggestion service 532 can direct processing system 550 to determine suggested cloud service providers for migrating current services, adding services, or providing some other configuration modification for the services using a different combination of sellers of record. The suggested sellers of record can be provided as a list, wherein the administrator associated with the organization can select at least one of the suggested sellers of record to support the modification. In some examples, suggestion service 532 directs processing system 550 to determine a score for each of the sellers of record based on any of the aforementioned factors and provides a list of one or more suggested providers based on the scores.

In some implementations, monitor service 530 directs processing system 550 to provide usage information associated with the sellers of record and/or cloud service providers. The usage information may include the number of virtual endpoints deployed in association with a seller of record or a corresponding cloud service provider, information about the services and applications deployed in association with a seller of record or a corresponding cloud service provider, computing resources used at each of the cloud service providers, or some other information. Advantageously, this may permit an administrator associated with an organization to monitor the resource usage and determine whether a current selection of sellers should be maintained during a next subscription period.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method comprising:
monitoring resource usage in association with one or more cloud service providers for each seller of record of a plurality of sellers of record for a customer organization;
for each seller of record of the plurality of sellers of record:
identifying interface requirements associated with reporting the resource usage for the seller of record; and
communicating the resource usage for the seller of record to a computing device associated with the seller of record in accordance with the interface requirements.

2. The method of claim 1, wherein the interface requirements comprise application programming interface (API) requirements associated with the seller of record.

3. The method of claim 1, wherein the resource usage comprises processing resource usage, memory resource usage, or physical network interface resource usage.

4. The method of claim 3, wherein monitoring the resource usage comprises receiving at least a portion of the resource usage from one or more agents in the one or more cloud service providers.

5. The method of claim 1, wherein the resource usage comprises one or more service identifiers for one or more services active in the one or more cloud service providers.

6. The method of claim 1 further comprising:
identifying a notification from a new seller of record to make one or more services available to the customer organization from a cloud service provider of the one or more cloud service providers;
monitoring resource usage in association with the one or more services in the cloud service provider;
identifying interface requirements associated with reporting the resource usage associated with the one or more services to the new seller of record; and
communicating the resource usage associated with the one or more services to a computing device associated with the new seller of record.

7. The method of claim 1 further comprising:
identifying a notification to migrate one or more services from a first seller of record in the plurality of sellers of record to a new seller of record; and
initiating a migration of the one or more services from the first seller of record to the new seller of record.

8. The method of claim 7, wherein the one or more services execute in a first cloud service provider of the plurality of cloud service providers under the first seller of record and execute in a second cloud service provider of the plurality of cloud service providers under the second seller of record.

9. The method of claim 7, wherein the one or more services execute in a first cloud service provider of the plurality of cloud service providers under the first seller of record and execute in the first cloud service providers under the second seller of record.

10. A computing apparatus comprising:
one or more computer readable storage media;
at least one processor operatively coupled to the one or more computer readable storage media; and
program instructions stored on the one or more computer readable storage media that, when executed by the at least one processor, direct the processing system to:
monitor resource usage in association with one or more cloud service providers for each seller of record of a plurality of sellers of record for a customer organization;
for each seller of record of the plurality of sellers of record:
identify interface requirements associated with reporting the resource usage for the seller of record; and
communicate the resource usage for the seller of record to a computing device associated with the seller of record in accordance with the interface requirements.

11. The computing apparatus of claim 10, wherein the interface requirements comprise application programming interface (API) requirements associated with the seller of record.

12. The computing apparatus of claim 10, wherein the resource usage comprises processing resource usage, memory resource usage, or physical network interface resource usage.

13. The computing apparatus of claim 12, wherein monitoring the resource usage comprises receiving at least a portion of the resource usage from one or more agents in the one or more cloud service providers.

14. The computing apparatus of claim 10, wherein the resource usage comprises one or more service identifiers for one or more services active in the one or more cloud service providers

15. The computing apparatus of claim 10, wherein the program instructions further direct the computing apparatus to:
identify a notification from a new seller of record to make one or more services available to the customer organization from a cloud service provider of the one or more cloud service providers;
monitor resource usage in association with the one or more services in the cloud service provider;
identify interface requirements associated with reporting the resource usage associated with the one or more services to the new seller of record; and
communicate the resource usage associated with the one or more services to a computing device associated with the new seller of record in accordance with the interface requirements.

16. The computing apparatus of claim 10, wherein the program instructions further direct the computing apparatus to:
identify a notification to migrate one or more services from a first seller of record in the plurality of sellers of record to a new seller of record;
initiate a migration of the one or more services from the first seller of record to the new seller of record.

17. The computing apparatus of claim 16, wherein the one or more services execute in a first cloud service provider of the plurality of cloud service providers under the first seller of record and execute in a second cloud service provider of the plurality of cloud service providers under the second seller of record.

18. The computing apparatus of claim 16, wherein the one or more services execute in a first cloud service provider of the plurality of cloud service providers under the first seller of record and execute in the first cloud service providers under the second seller of record.

19. An apparatus comprising:
one or more computer readable storage media; and
program instructions stored on the one or more computer readable media that, when executed by at least one processor, direct the at least one processor to:
identify a notification from a seller of record of a plurality of sellers of record to make one or more services available to a customer organization from a cloud service provider;
monitor resource usage in association with the one or more services in the cloud service provider;
identify interface requirements associated with reporting the resource usage to the seller of record;
communicate the resource usage associated with the one or more services to a computing device associated with the seller of record in accordance with the interface requirements;
identify a notification to migrate the one or more services from the seller of record to a second seller of record of the plurality of sellers of record;
initiate a migration of the one or more services from the seller of record to the second seller of record;
identify second interface requirements associated with reporting the resource usage to the second seller of record; and
after the migration, communicate the resource usage associated with the one or more services to a computing device associated with the second seller of record in accordance with the second interface requirements.

20. (canceled)
